(19) United States
(12) Patent Application Publication
(10) Pub. No.: US 2012/0075643 A1
(43) Pub. Date: Mar. 29, 2012

(54) Method of revising printing error in PCB

(75) Inventors: Kwansoo Yun, Suwon-si (KR); Dongik Joo, Seongnam-si (KR); Yunbae Kim, Suwon-si (KR); Yongsik Kim, Hwaseong-si (KR); Sangdo Cho, Anyang-si (KR)

(73) Assignee: SAMSUNG ELECTRO-MECHANICS CO., LTD., Suwon (KR)

(21) Appl. No.: 13/137,878

(22) Filed: Sep. 20, 2011

(30) Foreign Application Priority Data
Sep. 28, 2010 (KR) 10-2010-0093797

(51) Int. Cl. G06K 15/02

(52) U.S. Cl. 358/1.5

(57) ABSTRACT

Provided is a method of revising a printing error in a PCB, including acquiring alignment mark coordinates and recognition mark coordinates formed at corners of each sheet through design specification information of the PCB, acquiring distorted alignment mark coordinates and recognition mark coordinates of each sheet through actually measured information of the PCB, calculating coordinate information acquired from the design specification information of the PCB and coordinate information acquired from the actually measured information of the PCB to acquire a revision coefficient, calculating an actual deformation value of the PCB using the revision coefficient, and converting the actual deformation value into deformation data of a binary image applied to the design specification information to be revised, and performing a printing operation on the PCB using the deformation data as a reference.

### CROSS-REFERENCE TO RELATED APPLICATIONS

This application claims the benefit of Korean Patent Application No. 10-2010-0093797 filed with the Korea Intellectual Property Office on Sep. 28, 2010, the disclosure of which is incorporated herein by reference.

### BACKGROUND OF THE INVENTION

1. Field of the Invention

The present invention relates to a method of revising a printing error in a printed circuit board (PCB), and more particularly, to a method of revising a printing error in a PCB including measuring deformation of the PCB to calculate a revision coefficient, and calculating a local revision value of the deformed PCB through a binary image on the basis of the revision coefficient, so that accurate printing can be performed using the local revision value.

2. Description of the Related Art

In general, a PCB produced as a plate-type product is designed to provide a multi-layered circuit design to form a plurality of circuit patterns, applying electric signals. Here, a layout of the PCB is configured such that various kinds of circuits, holes and solder masks are formed on a PCB panel as a raw material, and a design of the layout is transferred to the PCB panel using, generally, a laser.

In addition, the PCB may have components such as circuit patterns, vias or holes, and so on, formed on the PCB panel as a raw material through a photography process. When numerical variation in the PCB raw material occurs during production through a plurality of processes, differences between design positions and actual positions of the respective features of the PCB occur. In particular, in a manufacturing process of the PCB, an important design issue is to maintain intervals between the features such as a plurality of holes, circuit patterns, and so on. When the PCB panel expands or contracts during the manufacturing process, interferences or short circuits may occur between adjacent circuits.

Further, when the plurality of holes are interlayer connection holes formed in a multi-layered PCB, the holes formed in the PCB must be accurately aligned and intervals between the holes must be equal to the design value to manufacture PCBs having high yield.

If the PCB alignment between the PCB panels as a raw material of the PCB goes wrong during the PCB manufacturing process or the PCB panel expands or contracts, paste may be printed outside an allowable range due to the expansion or contraction, other than being appropriately printed on a printing region, during screen or inkjet printing, occurring a printing error of a final product.

In order to accurately perform the printing process on the PCB, three or four alignment marks are formed on each PCB panel as a raw material. While the alignment marks are used as a reference when revision of the PCB deformation is needed, in the case of most PCB panels, since the alignment marks are formed at corners of the PCB panel, revision of the printing error during the printing process of the PCB panel could be applied to only the entire deformation of the PCB panel.

Meanwhile, as described above, the screen printing method and the inkjet printing method can be applied to the printing process, which may be employed in the PCB manufacturing process. Here, the screen printing method is a method of matching a PCB and a mask using the mask and squeezing ink to a required portion of the PCB panel to perform the printing operation. However, as the printing operation is performed, transfer properties or reproducibility of printed characters may decrease.

In this screen printing method, since the PCB panel is aligned through the alignment marks formed thereon in a three- or four-point manner and tension of the expanded or contracted portion of the PCB panel is manually adjusted using tapes, and so on, in a direction that the deformation is occurred, the tension cannot be easily adjusted, and a fraction defective may be determined by an operator's skill.

In addition, the inkjet method is a method of ejecting liquefied ink through a print head and locating the print head on the PCB to print a desired shape. When the PCB is expanded or contracted during the PCB manufacturing process, revision of the deformation is performed by inflecting an average value of the deformation with respect to the four alignment marks formed at corners of the PCB. As a result, when a local expansion or contraction or a deformation of about 50 μm or more occurs in the PCB, revision of the printing error is impossible.

### SUMMARY OF THE INVENTION

The present invention has been invented in order to overcome the above-described problems and it is, therefore, an object of the present invention to provide a method of revising a printing error of a PCB including calculating a revision coefficient using design information and actually measured information of alignment marks formed on corners of a PCB and recognition marks formed at outer peripheries of a plurality of sheets divided on the PCB, converting an actually-deformed value of the PCB calculated using the calculated revision coefficient into a binary image to apply the binary image to a PCB printing apparatus, and revising the design information of the PCB having a local expansion/contraction deformation according to the actually measured information to perform a printing operation without error.

In accordance with one aspect of the present invention to achieve the object, there is provided an method of revising a printing error in a PCB, including: acquiring alignment mark coordinates and recognition mark coordinates formed at corners of each sheet through design specification information of the PCB; acquiring distorted alignment mark coordinates and recognition mark coordinates of each sheet through actually measured information of the PCB; calculating coordinate information acquired from the design specification information of the PCB and coordinate information acquired from the actually measured information of the PCB to acquire a revision coefficient; calculating an actual deformation value of the PCB using the revision coefficient, and converting the actual deformation value into deformation data of a binary image applied to the design specification information to be revised; and performing a printing operation on the PCB using the deformation data as a reference.

In acquiring the alignment mark coordinates and the recognition mark coordinates from the actually measured information of the PCB, a selection position of the coordinate information may select a printing start position of the PCB as a reference position, and coordinates of adjacent positions may be sequentially selected about the reference point.

Here, the coordinate information acquired from the actually measured information of the PCB may be sequentially obtained from adjacent coordinates from a printing start position, and four coordinates formed at corners of each sheet installed on the PCB may be selected.

In addition, the coordinate information acquired from the actually measured information of the PCB may be selected as four coordinates formed at corners of a plurality of grouped sheets disposed on the PCB.

Further, in acquiring the alignment mark coordinates and the recognition mark coordinates from the actually measured information of the PCB, the alignment mark coordinates and the recognition mark coordinates may be acquired as coordinate information through a scanning process using an imaging apparatus in which a CCD or a CMOS is employed.

Here, the coordinate information acquired from the actually measured information of the PCB is the same coordinate information as coordinate information acquired from the design specification information of the PCB.

Meanwhile, in calculating the revision coefficient, the revision coefficient is calculated using the following bilinear function formula using the coordinate information acquired from the design specification information of the PCB and the actually measured information of the PCB:

Formula

u(x,y)=a0+a1x+a2y+a3xy

wherein x, y: coordinates of design specification information of PCB

x′, y′: coordinates of actually measured information of PCB, and

a0 to a3: revision coefficient.

Here, the method of revising a printing error may further include, after calculating the revision coefficient, further acquiring vector data of each sheet from the design specification information of the PCB.

The vector data may be coordinate information for character printing or silk screen, and an actual deformation value may be calculated by applying the revision coefficient to the vector data extracted from the actually measured information and the design specification information of the PCB.

Here, shift and rotation of each sheet, X- and Y-axis expansion/contraction, and deformation of expansion/contraction in a diagonal direction may be calculated by the actual deformation value, which may be applied to the PCB, using coordinate information in a diagonal direction and X- and Y-axis coordinate information of each sheet of the PCB, and the extracted actual deformation value may be converted into deformation data that can be applied to a printing apparatus.

Meanwhile, in converting the actual deformation value into the deformation data of the binary image, the binary image may be stored as a bitmap image. The binary image may be applied to the printing apparatus so that the vector data can be printed with respect to the revised deformation data on the basis of the actual deformation value.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic view of a PCB applied to the present invention;

FIG. 2 is a schematic view showing a deformed state of an individual sheet formed on the PCB of FIG. 1;

FIG. 3 is a flowchart showing a method of revising a printing error in a PCB in accordance with an exemplary embodiment of the present invention;

FIG. 4 is a view for explaining coordinates of a PCB employed in the method of revising a printing error in accordance with the present invention; and

FIG. 5 is a schematic view showing deformed patterns of the PCB that can be revised by the present invention.

### DETAILED DESCRIPTION OF THE PREFERABLE EMBODIMENTS

Hereinafter, embodiments of the present invention for a method of revising a printing error in a PCB will be described in detail with reference to the accompanying drawings. The following embodiments are provided as examples to fully convey the spirit of the invention to those skilled in the art.

Therefore, the present invention should not be construed as limited to the embodiments set forth herein and may be embodied in different forms. And, the size and the thickness of an apparatus may be overdrawn in the drawings for the convenience of explanation. The same components are represented by the same reference numerals hereinafter.

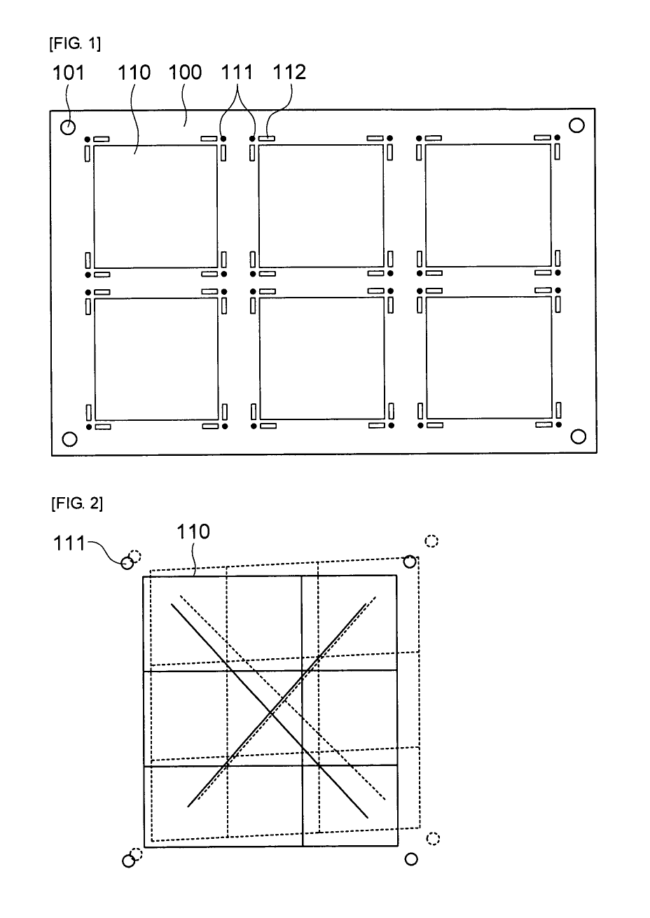

FIG. 1 is a schematic view of a PCB applied to the present invention, and FIG. 2 is a schematic view showing a deformed state of an individual sheet formed on the PCB of FIG. 1.

As shown, a PCB 100 to which a method of revising a printing error in accordance with the present invention is applied may be a plate-shaped panel, on which a plurality of sheets 110 are formed at predetermined intervals.

In addition, alignment marks 101 are formed on outer peripheries, i.e., four corners, of the PCB 100, and recognition marks 111 are formed at four corners of each of the plurality of sheets 110 formed of the PCB 100. At this time, the recognition marks 111 formed at corners of the plurality of sheets 110 may be formed on perforated lines 112 of each sheet 110.

The PCB 100 configured as described above is surface-treated through a plurality of processes, and a plurality of PCBs may be laminated and matched to form a multi-layered PCB. In addition, in order to protect a surface layer and a circuit pattern of the PCB 100 and form characters using a silk screen, and so on, paste or ink may be printed on the surface of the PCB 100 through a printing process.

The PCB 100 passes through a plurality of processes to generate deformations such as expansion/contraction, shift, rotation, and so on, in an X-Y axis or a diagonal direction as shown in FIG. 2. In FIG. 2, information of an individual sheet and its recognition marks acquired from design specification information of the PCB may be represented as solid lines, and information of a deformed individual sheet and its recognition marks acquired from actually measured information of the PCB may be represented as dotted lines. In addition, as the number of layers of the PCB is increased, the deformation becomes also serious. When the printing is performed according to the design information of the deformed PCB, the printing error may occur due to variation in printing position of the actual PCB.

Therefore, the present invention is provided to improve matching property during the printing process on the surface of the PCB in which the deformation actually occurred, information of four coordinates is locally set from coordinate information including the align marks 101 formed at corners of the PCB 100 and the recognition marks 111 formed at corners of an individual sheet 110, a revision coefficient thereof is calculated, and then, the revision coefficient is applied to the design specification information of the PCB, minimizing the printing error when the PCB is locally deformed.

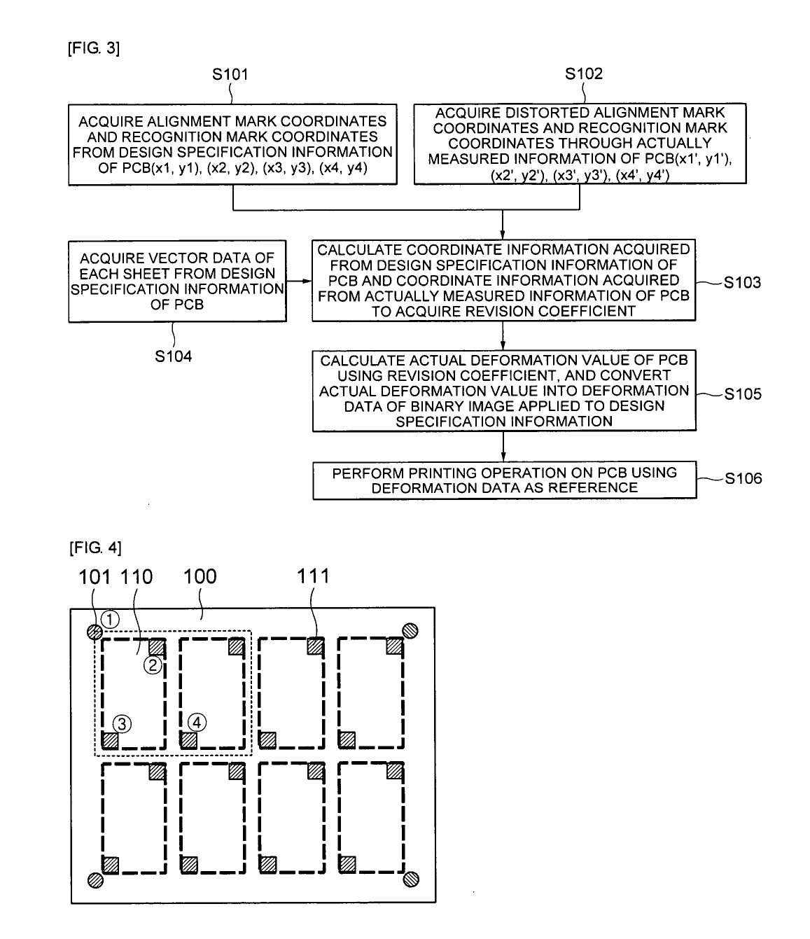

Hereinafter, a method of revising a printing error using the coordinate information setting of the PCB and the set coordinate information will be described in detail with reference to FIGS. 3 and 4.

FIG. 3 is a flowchart showing a method of revising a printing error in a PCB in accordance with an exemplary embodiment of the present invention, and FIG. 4 is a view for explaining coordinates of a PCB employed in the method of revising a printing error in accordance with the present invention.

As shown, in the method of revising a printing error in a PCB in accordance with the present invention, first, coordinates of alignment marks 101 and coordinates of recognition marks 111 formed at corners of a PCB 100 are acquired through design specification information of the PCB 100 (S101).

The design specification information of the PCB 100 may be extracted ODB++ files in which position information of sheets 110 are stored in a plurality of layers of the PCB, respectively.

Next, coordinates of the alignment marks 101 and coordinates of the recognition marks 111 of the deformed PCB are acquired through actually measured information of the PCB 100 (S102). At this time, the actually measured information of the PCB may be extracted through photograph information of an imaging apparatus in which a CCD or a CMOS movable on the PCB is mounted, a reference point of the coordinate information acquired from the actually measured information of the PCB may be selected with respect to a printing start point, and information of four coordinates including the alignment marks 101 and the recognition marks 111 may be selected with respect to the printing start point.

At this time, as shown in FIG. 2, the information of the four coordinates may be four recognition marks 111 formed at corners of the individual sheet 110 formed on the PCB 100.

Meanwhile, in this embodiment, as the plurality of sheets is grouped, the four recognition marks 111 formed at corners of the grouped sheets are sequentially selected to correspond to local deformation of the PCB. In addition, the number of the recognition marks 111 recognized by the imaging apparatus when the PCB is scanned using the imaging apparatus is decreased to reduce a scanning time of the PCB upon mass production.

Referring to FIG. 4, when adjacent two sheets 110 are grouped to acquire information of four coordinates, the recognition marks 111 formed at positions adjacent to the recognition marks formed on the two sheets 110 including the alignment marks 101 formed on the PCB 100 are sequentially selected.

At this time, when the recognition marks 111 of the adjacent sheets are sequentially selected with respect to the alignment mark 101 of a number □ as a reference point, in a state in which the two sheets 110 are grouped, four coordinates of numbers □ to □ may be set in a zigzag (Z-shape) direction to extract coordinate information of the actually measured information.

Here, the coordinate information acquired from the actually measured information of the PCB 100 may be acquired as the information of the same coordinates as the coordinate information acquired from the design specification information of the PCB 100.

Next, the coordinate information acquired from the design specification information of the PCB 100 and the coordinate information acquired from the actually measured information of the PCB 100 are calculated through the following formula of a bilinear function to calculate a revision coefficient (S103).

At this time, the formula of the bilinear function is as follows.

u(x,y)=a0+a1x+a2y+a3xy [Formula 1]

Here, x, y: coordinates of design specification information of PCB

x′, y′: coordinates of actually measured information of PCB

a0 to a3: revision coefficient

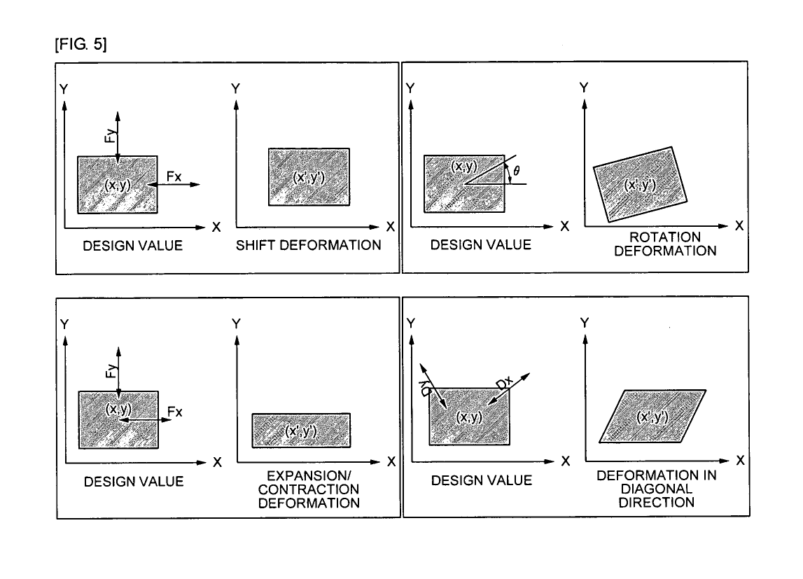

A deformation type of the PCB extracted from the actually measured information of the PCB will be represented as shown in FIG. 5 using the formula 1, and a modified formula for calculating a revision coefficient using the formula 1 will be represented as the following formula 2.

x=a0+a1x+a2y+a3xy

y=b0+b1y+b2x+b3xy [Formula 2]

Here, a0 and b0 are shift coefficients. When a0 and b0 have a value of 0, it may be determined that there no shift. In addition, a1 and b1 are coefficients of expansion/contraction, and a2 and b2 are location coefficients. When a2 and b2 have a value of 0, it may be determined that there is no location. In addition, a3 and b3 are coefficients of diagonal deformation. When a3 and b3 have a value of 0, it may be determined that there is no diagonal deformation.

At this time, coordinate information extracted from the design specification information of the PCB using the formula 2 and coordinates extracted from the actually measured information are calculated through the following formula 3 to acquire revision coefficients of a0 to a3 and b0 to b3.

x1=a0+a1x1+a2y1+a3x1y1

x2=a0+a1x2+a2y2+a3x2y2

x3=a0+a1x3+a2y3+a3x3y3

x4=a0+a1x4+a2y4+a3x4y4

y1=b0+b1y1+b2x1+b3x1y1

y2=b0+b1y2+b2x2+b3x2y2

y3=b0+b1y3+b2x3+b3x3y3

y4=b0+b1y4+b2x4+b3x4y4 [Formula 3]

Next, as shown in FIG. 2, linear vector data are further acquired from the design specification information of the PCB, in addition to the coordinates of the recognition marks 111 formed at corners of each sheet 110 (S104).

The vector data are coordinate information for character printing or silk screen, which may be linearly formed in a diagonal direction of the sheet 110, and the revision coefficient is applied to the vector data to apply the revision coefficient extracted from the actually measured information of the PCB and the design specification information, calculating the actual deformation value.

That is, the actual deformation values calculated from the deformed PCB using the revision coefficients of a0 to a3 and b0 to b3 are applied to the linear vector data extracted from the design specification information to be converted into deformation data (S105).

At this time, the deformation data converted by the actually deformed value are applied to the coordinate information including the alignment marks and the recognition marks extracted from the design specification information of the PCB to be converted into deformation data in which shift and rotation of the individual sheet or the grouped sheets, expansion/contraction in X- and Y-axis directions and deformation in diagonal directions are calculated.

The deformation data may be converted into deformation data of a binary image. As the binary image is generally stored as a bitmap image to be app lied to the printing apparatus, the printing is performed to the PCB to the entirely or locally deformed PCB with respect to the deformation data (S106).

As can be seen from the foregoing, the method of revising a printing error in a PCB in accordance with the present invention can revise locally deformed coordinates of the PCB through the actually measured information extracted from the individual sheet or the grouped sheets and the design specification information of the PCB when the PCB is inevitably deformed during the PCB manufacturing process, enabling the printing operation without a printing error. In addition, when each sheet is locally deformed of the PCB is deformed to 50 μm or more, since local revision of the deformation can be performed by the coordinate information extracted from each sheet, it is possible to accurately perform the printing operation on the PCB.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. A method of revising a printing error in a PCB, comprising:
acquiring alignment mark coordinates and recognition mark coordinates formed at corners of each sheet through design specification information of the PCB;
acquiring distorted alignment mark coordinates and recognition mark coordinates of each sheet through actually measured information of the PCB;
calculating coordinate information acquired from the design specification information of the PCB and coordinate information acquired from the actually measured information of the PCB to acquire a revision coefficient;
calculating an actual deformation value of the PCB using the revision coefficient, and converting the actual deformation value into deformation data of a binary image applied to the design specification information to be revised; and
performing a printing operation on the PCB using the deformation data as a reference.

2. The method of revising a printing error in a PCB according to claim 1, wherein, in acquiring the alignment mark coordinates and the recognition mark coordinates from the actually measured information of the PCB, a selection position of the coordinate information selects a printing start position of the PCB as a reference position, and coordinates of adjacent positions are sequentially selected about the reference point.

3. The method of revising a printing error in a PCB according to claim 2, wherein the coordinate information acquired from the actually measured information of the PCB is selected as four coordinates formed at corners of each sheet installed on the PCB.

4. The method of revising a printing error in a PCB according to claim 2, wherein the coordinate information acquired from the actually measured information of the PCB is selected as four coordinates formed at corners of a plurality of grouped sheets disposed on the PCB.

5. The method of revising a printing error in a PCB according to claim 4, wherein, in a state in which the sheets are grouped, the four coordinates are set in a zigzag (Z-shape) direction to extract coordinate information from the actually measured information of the PCB.

6. The method of revising a printing error in a PCB according to claim 1, wherein, in acquiring the alignment mark coordinates and the recognition mark coordinates from the actually measured information of the PCB, the alignment mark coordinates and the recognition mark coordinates are acquired as coordinate information through a scanning process using an imaging apparatus in which a CCD or a CMOS is employed.

7. The method of revising a printing error in a PCB according to claim 6, wherein the coordinate information acquired from the actually measured information of the PCB is coordinate information of a position corresponding to coordinate information acquired from the design specification information of the PCB.

8. The method of revising a printing error in a PCB according to claim 1, wherein, in calculating the revision coefficient, the revision coefficient is calculated using the following bilinear function formula using the coordinate information acquired from the design specification information of the PCB and the actually measured information of the PCB:
Formula
u(x,y)=a0+a1x+a2y+a3xy
wherein x, y: coordinates of design specification information of PCB
x′, y′: coordinates of actually measured information of PCB
a0 to a3: revision coefficient.

9. The method of revising a printing error in a PCB according to claim 1, further comprising, after calculating the revision coefficient, further acquiring vector data of each sheet from the design specification information of the PCB.

10. The method of revising a printing error in a PCB according to claim 9, wherein the vector data are coordinate information for character printing or silk screen, and an actual deformation value is calculated by applying the revision coefficient to the vector data extracted from the actually measured information and the design specification information of the PCB.

11. The method of revising a printing error in a PCB according to claim 1, wherein, in converting the actual deformation value into the deformation data of the binary image, the binary image is stored as a bitmap image.
